(19) United States
(12) Patent Application Publication
(10) Pub. No.: US 2004/0250908 A1
(43) Pub. Date: Dec. 16, 2004

(54) Method and system configured to manage a tree harvesting process

(76) Inventor: Keith B. Hicks, Somonauk, IL (US)

Correspondence Address: CATERPILLAR INC., 100 N.E. ADAMS STREET, PATENT DEPT., PEORIA, IL, 616296490

(21) Appl. No.: 10/324,467

(22) Filed: Dec. 19, 2002

(51) Int. Cl. A01G 23/08

(52) U.S. Cl. 144/335

(57) ABSTRACT

A method and system configured to monitor a tree harvesting process is provided. The method includes the steps of establishing a plurality of characteristics of a tree harvesting process associated with a first location, delivering the plurality of characteristics to a second location, and monitoring the tree harvesting process in response to the plurality of characteristics

### TECHNICAL FIELD

This invention relates generally to a method and system associated with a tree harvesting process, and more particularly, to a method and apparatus configured to manage a tree harvesting process.

### BACKGROUND

A tree harvesting process may include several activities, or phases. For example, a tree harvesting process may include the cutting down of one or more trees, the relocation of the cut tree(s) to a region where they may be processed, if desired, and the transportation of the trees from the processing region, to a processing facility, such as a saw mill. The management of a tree harvesting process is based on pre-determined work assignments being manually distributed to operators prior to the beginning of a shift. The work assignments are based upon outdated information regarding the activities taking place in the harvesting process. In addition, as the harvesting process proceeds, the operators are unable to respond to changes in the work flow. These issues make it difficult to manage a harvesting process and lead to significant inefficiencies.

In addition, the present harvesting operations do not provide concurrent process development, which causes long lead times and inefficient operation. The present systems also do not provide real time environmental compliancy data, to facilitate alternate harvesting and processing methods quickly enough.

The present invention is directed to overcoming one or more of the problems set forth above.

### SUMMARY OF THE INVENTION

In one aspect of the present disclosure, a method of managing a tree harvesting process is disclosed. The method includes the steps of establishing a plurality of characteristics of the tree harvesting process at a first location, delivering the plurality of characteristics to a second location, and managing the tree harvest process in response to the plurality of characteristics.

In another aspect of the present disclosure, a system configured to manage a tree harvesting process is disclosed. The system includes a local harvest monitoring system configured to establish a plurality of tree harvesting characteristics associated with the tree harvesting process and responsively generate a signal, the signal being indicative of at least a portion of the tree harvesting characteristics, and a remote data facility configured to receive the signal and manage the tree harvest process in response to the tree harvesting characteristics.

### BRIEF DESCRIPTION OF THE DRAWINGS

FIG. 1 is an illustration of one embodiment of a tree harvesting process;

FIG. 2 is an illustration of one embodiment of a tree harvesting monitoring system;

FIG. 3 is an illustration of one embodiment of a local harvest monitoring system;

FIG. 4 is an illustration of one embodiment of a mobile communicator, and

FIG. 5 is an illustration of one embodiment of a method of managing a tree harvest process

### DETAILED DESCRIPTION

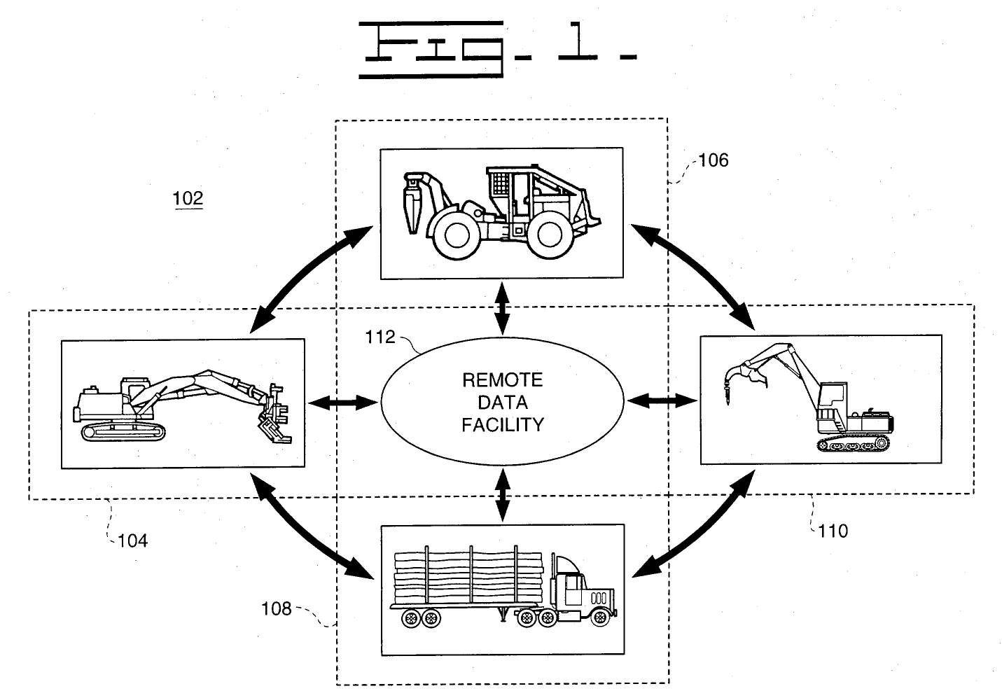

The present disclosure provides a method and apparatus of managing a tree harvesting process, or a portion thereof. FIG. 1 is an illustration of one embodiment of a tree harvesting process 102. The tree harvesting process may include multiple phases, such a tree cutting phase 104, a tree relocation phase 106, and a tree transportation phase 108.

In a tree cutting phase 104, at least one tree is cut down by a piece of equipment. The tree cutting phase 104 may be performed by a tree cutting piece of equipment, or machine, such as a feller buncher, a harvester/processor, or even a person manually handfelling. A feller buncher is a piece of equipment that is able to cut a tree, and then, if desired, carry the cut tree to another location. Therefore, two or more cut trees may be grouped into a pile, or a bunch. In one embodiment, the grouping of cut trees may be considered to be a defined phase of the harvesting process, which may be a part of the tree cutting phase, or its own separate phase.

In a tree relocation phase 106 of the process 102, the cut tree(s) may be relocated from the region they were cut to a second region where they may be transported. As will be described, the tree(s) may be processed before being transported. A tree relocating piece of equipment, or machine, such as a skidder-forwarder, cable yarder, and/or shovel logger may be used to carry one or more of the cut trees to the second region. The tree relocating equipment may load multiple trees located in a bunch, or maneuver around and pick up cut trees if the trees are not bunched. Once an appropriate load is obtained, the equipment relocates the cut trees to the processing region (if one is used) and/or transportation region. In one embodiment, the cut trees may be processed and/or loaded for transportation from the location they were cut, in which case a tree relocation phase, or process, may not be utilized.

In one embodiment, the cut trees may be processed before they are transported. The processing may include the activities such as delimbing, topping, bucking to lengths, sorting, and/or chipping the trees. The processing may be done to assist in the transportation of the cut trees, to pre-process the trees before deliver to a processing facility, and/or to process some of the tree for distribution back in the harvesting area. Therefore, there the tree harvesting process may be a processing phase/region. The processing phase/region may be viewed as separate phase/region, or a subset of the transportation phase/region. Once the trees are processed they may be delivered to the tree transportation region if it is a physically different region.

In one embodiment, tree processing may occur after the tree has been cut and before the tree has been relocated. For example, there may be a piece of equipment that delimbs the tree once it has been cut. In addition, tree byproducts may be processed in the tree cutting region before tree relocation.

In a tree transportation phase 108 the cut tree(s) are loaded onto a piece of equipment for transportation. The trees may be transported to a remote processing facility, e.g., a saw mill. The transportation equipment may include a truck configured to carry the cut trees, or portions thereof, a boat, a barge, a train, or other equipment capable of transporting cut trees. In one embodiment, the transportation process may include tagging the cut trees and placing them in a river to float to a processing facility, or a second transportation location where they are taken from the river and placed in a piece of transportation equipment to be delivered to a processing facility. Once the processing has been performed, the tree may be loaded onto the transportation equipment. In addition, the residual from the processing of the tree, e.g., the limbs, tops and/or bark, may be further processed and/or loaded onto a truck, for example, for transportation.

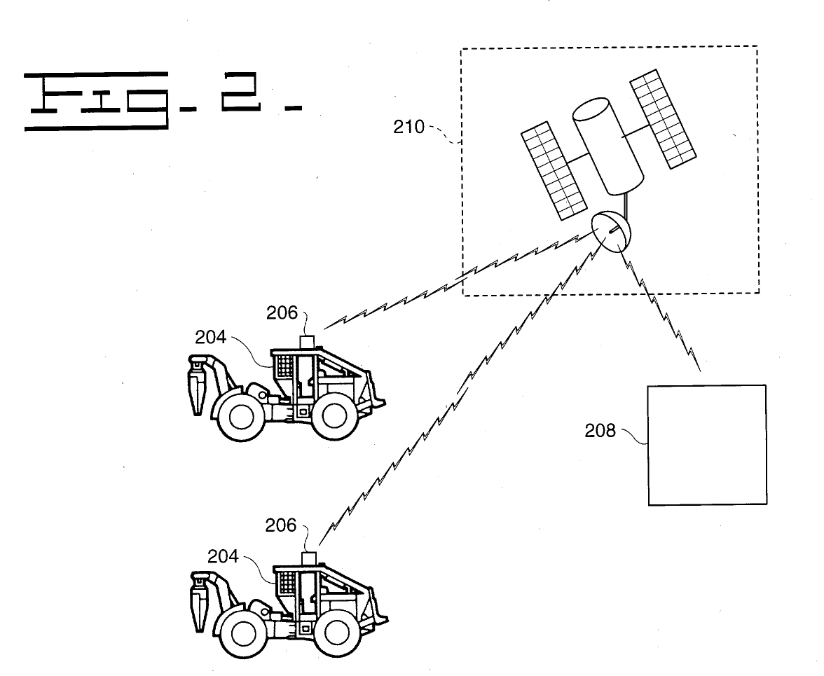

FIG. 2 illustrates one embodiment of a tree harvest monitoring system 202. The system 202 may include a plurality of mobile communicators 206, each associated with a machine 204, person (not shown) or function. The mobile communicators 206 may be configured to communicate with a remote data facility 208, and/or each other through a communication network 210.

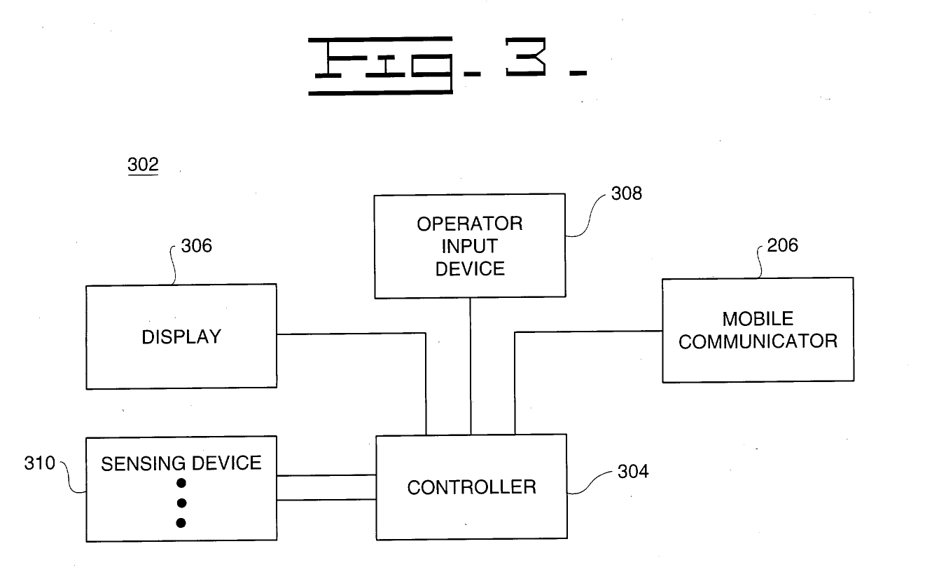

In one embodiment, the mobile communicator 206 is part of a local harvest monitoring system 302, associated with the equipment 204, illustrated in FIG. 3. The local harvest monitoring system 302 may include a controller 304 configured to establish a plurality of characteristics associated with said tree harvesting process and a mobile communicator 206 to deliver said plurality of characteristics to a second location. The controller 304, or processing unit, may receive information from one or more equipment sensing devices 310, e.g., engine sensing device, fuel sensing device, payload management sensing devices, hour meter sensing devices etc, and other electronic elements on the machine. The controller 304 may deliver information to the communicator 206 to be transmitted to another mobile communicator 206 or the remote facility 208, and to receive information/request from these other devices. In addition, the controller 304 may be connected to a display 306 for displaying relevant information to the operator. The controller 304 may be connected to an operator input device 308 (e.g., keypad, touch screen display, joystick controlled display etc.) for receiving information from the operator. In one embodiment, the mobile communicator 206 may include the controller 304. The local harvest monitoring system 302 may include a memory device (not shown) for storing information associated with the harvesting process. The information may be stored in a database located in the memory device. In one embodiment, the memory may be included in the controller 304.

In one embodiment, the tree harvesting process may include a remote facility 208. The remote facility may perform one or more functions, such as harvest coordination, data collection, and/or data analysis. A remote facility 208 is configured to communicate with the mobile communicator 206 located on the equipment(s) via the communication network 210. The remote facility may be a remote station, a monitoring facility, a central data facility, or other facility capable of exchanging information with at least one mobile communicator 206. Examples of a remote facility 208 may include a call-center, dealer office, a manufacturer's office, a corporate office, a customer office, the office of a third party involved in monitoring the process or a portion thereof, a facility located local to the harvesting process, or other fixed or mobile offices capable of communicating and processing equipment/process information, or passing the information to another remote facility to perform this analysis. The remote monitoring station may be operated by a manufacturer, dealer, end-user, process owner, land owner, or third party. The remote monitoring station may be located within or close to the area to be harvested, or at a facility situated at a remote location.

In one embodiment, the remote facility 208 may be adapted to communicate with a remotely located end-user. Examples of end users includes, equipment owners, equipment operators, contractors, rental fleet managers, service/maintenance department managers, and security departments, process owner, land or tree owner etc. The remote facility 208 may include one or more computer workstations networked together for communicating with the mobile communicators 206 and/or the end-users.

In one embodiment, the mobile communicator 206 may be able to communicate with a second mobile communicator 206 and/or a remote data facility 208, by a communication network 210. In one embodiment, the communication network 210 may include a wireless communication technique. The wireless communication techniques may include satellite communication, a cellular network, radio frequency communication devices and/or other forms of wireless communication. In addition, in one embodiment, the communication network may include wired communication techniques such as a modem with access to a public, or private, telephone line. Therefore, the communication network 210 may include a wireless network, wired network, or a combination thereof.

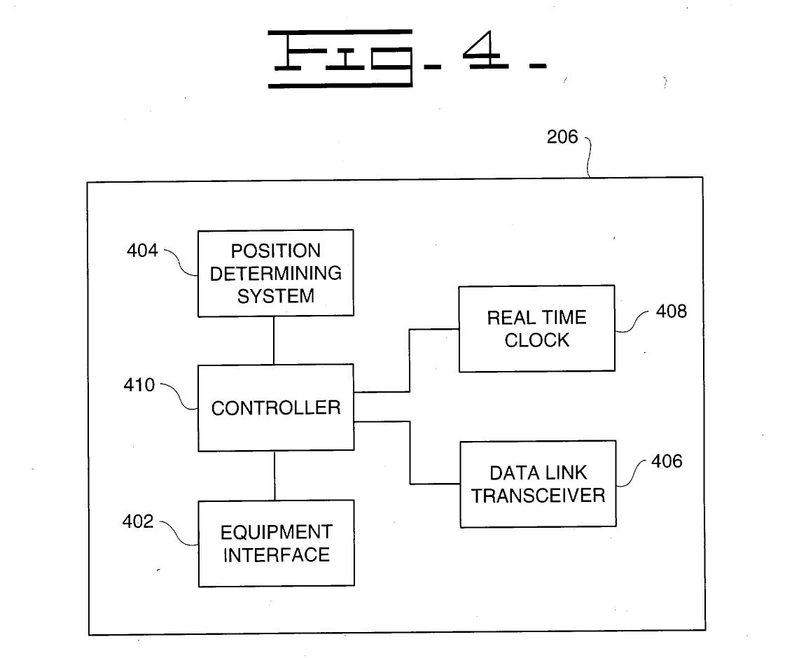

FIG. 4 illustrates one embodiment of a mobile communicator 206. In one embodiment, the communicator 206 is electronically connected, e.g., via an equipment interface 402, to the equipment 204 in order to receive power from the equipment 204, and/or transfer equipment/process related information to and from the equipment 204. In an alternative embodiment, the mobile communicator 206 may include its own power source. In one embodiment, the mobile communicator 206 may include a position determining system 404. The position determining system may include a GPS receiver and associated hardware and software, for receiving and determining machine location related information. Based on the location information, the mobile communicator 206 may determine the location of the equipment 204, portions of the equipment, or elements associated with the process. Alternatively, the position determining system 404 may be located on the equipment 204, and the machine location information delivered to the mobile communicator 206 as needed.

The mobile communicator 206 may include a wireless data link transceiver 206 to communicate with a remote facility 208, or other mobile communicator 206, via the communication network 210. In one embodiment, the data link is a wireless communication link. In one embodiment, the wireless communication link may include a satellite data link, cellular data link, radio frequency data link, or other form of wireless data link. In addition the network may include a local data link (not shown) for access by service personnel. The mobile communicator 206 may include a real time clock 408 from which the time of day and date may be determined.

The mobile communicator 206 may also include a controller 410. The controller 410 may be configured to receive messages from the remote facility 208, another mobile communicator, position information from the positioning system 404, time information from the real time clock 408, equipment information from a equipment interface 402, and responsively monitor the position, time and/or operation of the machine 204, and deliver the monitoring information to the remote facility station 208, or another mobile communicator 206. The controller 410 may also include memory for storing information when appropriate. The memory may include a database (not shown) having information associated with the harvesting process. Alternatively, a separate memory device may be included in the mobile communicator 206.

In one embodiment, the mobile communicator 206 may be a hand held device capable of communicating with another mobile communicator 206 or a remote facility. In addition the mobile communicator 206 may be able to receive information from radio frequency transmitters located on the equipment, and thereby receive information from the equipment associated with either the equipment or the tree harvesting process.

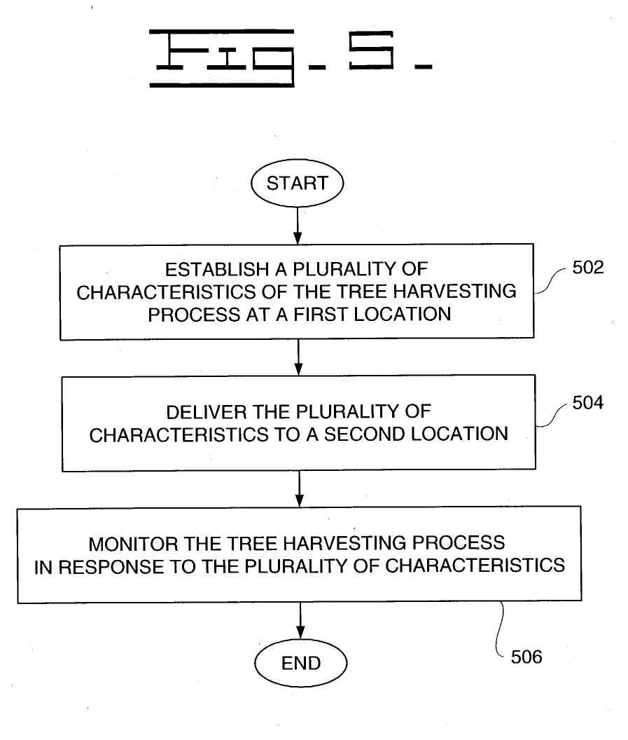

FIG. 5 illustrates one embodiment of a method of the present invention. The present invention includes a method of monitoring a tree harvesting process, comprising the steps of establishing a plurality of characteristics of the tree harvesting process at a first location, delivering the characteristics to a second location, and monitoring the tree harvest process in response to the characteristics.

In a first control block 502, a plurality of characteristics of the tree harvesting process are established at a first location. The location may be a physical location, relative location, or combination thereof. A physical location may include a particular coordinate or a designated region or area. For example, a relative location may include a location that is relative to the machine, i.e., the equipment establishes a plurality of characteristics as it performs various activities. The established characteristics may include characteristics associated with the tree cutting phase. For example, before or after the tree is cut down, characteristics of the tree, which may include the diameter, species, density, moisture content of the tree, and location, may be determined. In one embodiment, one or more of these characteristics may be determined manually. For example, the operator of the equipment may visually inspect the tree to be cut (or that has been cut) to make this determination. The operator may use additional tools if needed, such as a tape measure to measure the diameter of the tree. Once the characteristics have been determined, the information may be delivered to a mobile communicator 206 through the use of an operator input device 308.

The operator may be able to utilize the tree cutting machine to determine the information in an automated manner. For example, a machine, such as a feller may determine a diameter by using diameter sensing devices such as arm encoders and/or photocell eyes. The information sensed by these devices may then be used to determine the diameter of the tree in an automated, or semi-automated manner. In one embodiment, a scanner may be used to determine the species and/or density, by using x-ray and laser scanning devices. The information sensed by these devices enables the species type and diameter to be determined. Once a tree has been cut down additional characteristics may be determined, such as the weight of the tree, and the stump height. In one embodiment, the weight of a tree may be determined by the use of payload sensors on vehicle linkage. A linkage/skid encoder, photocell and lazer may be utilized to determine stump height and/or diameter. In one embodiment, once established, the characteristics may be stored in a memory (not shown), e.g., in a database located in a memory device or portion of a device, before being transmitted via the mobile communicator 206 to a second location. The memory device may be located on the equipment or mobile communicator 206. The memory device may be included in the controller 304. Alternatively, the characteristics may be transmitted upon being established.

In one embodiment of a tree harvesting process, a grouping phase may be performed, e.g., the bunching of cut trees into a group. If cut trees are bunched, this activity may occur during the tree cutting phase. Alternatively the grouping phase may be viewed as a separate phase. Once the tree is cut, equipment, such as the equipment that cut the tree, e.g., a feller-buncher, may pick the cut tree up and move the tree to a location where other cut trees are located. In this manner, the cut trees are bunched together. Additional characteristics may be established during this portion of the process, including the number of trees in a bunch, the weight, or total weight of the trees in the bunch, and the location of the bunch. These characteristics may be manually established, e.g., via an operator input device, or automatically established, e.g., via sensed information such as a payload monitoring system and/or sensed machine operations.

In one embodiment, one or more characteristics associated with wheel slippage may be established during the tree cutting and/or tree grouping phase. Wheel slippage characteristics may include the amount of wheel slippage, and the location of the slippage. In one embodiment, individual wheel encoders may be used to detect the relationship between the drive wheel revolutions per minute. From this, a determination may be made regarding whether wheel slippage is occurring. Again, this information may be automatically and/or manually established.

The characteristics of the tree harvesting process that may be established in the tree relocation phase include determining the number of trips made carrying the trees to the processing/transportation region. In one embodiment, one trip includes the segment from the transportation region to the tree cutting region and back. Alternatively, a trip may be a portion of one or more segments from the processing/transportation region to the tree cutting region. The characteristics established during the relocation phase may also include the number of trees relocated, a tonnage of trees relocated, whether any trees where lost during the relocation, the location of any lost trees, the species of the trees, and characteristics associated with wheel slippage, e.g., the amount and/or location of the wheel slippage. The established characteristics may be either manually established and entered into the operator input device 308 or established through the use of sensing devices associated with the system, or a combination thereof. For example, in one embodiment, the tree relocating machine may be equipped with a sensing device such as a scale, or weight sensing device, and/or payload measuring device such that one or more parameters indicative of the weight of the trees being relocated may be sensed and used to determine the weight of the trees in a particular load or the total weight of the trees being carried to the processing/transportation region.

In one embodiment, characteristics indicative of a lost tree may be established. A lost tree may include a tree that has fallen off the equipment during the relocation phase. A lost tree may also include a tree that is lost or misplaced during other phases, such as the tree cutting phase. In one embodiment, a characteristic indicative of a lost tree may be a characteristic indicative of weight. For example, if the weight of the trees being transported is being monitored, and the weight changes by more than a threshold amount while the equipment is in motion, then a tree may have been determined to have fallen off the equipment. Alternatively, engine parameters may be monitored to determine if there is a change in equipment load that may indicate a tree has fallen off the equipment. For example, if the throttle input remains in the same position, however the equipment speed has increased, then it may be determined that a tree has fallen off. In addition, a level sensing device may be used to indicate if the grade of the terrain the machine is traversing has changed such that the change would account for the change in machine speed. If a tree has fallen off the machine, then the time or location where the tree fell off may be established. For example, if positioning information is available, then the position of the machine where an indication of a potential dropped tree was detected, may be stored. The established position may then be used to determine the location of the dropped tree. That is, the position may provide an indication of where to begin looking for the tree. Other established characteristics may include the direction of the equipment at the time of the indication. Therefore, if the location and direction of the equipment may be established, the equipments path may be retraced to locate the tree. Alternatively, the time the tree fell off may be recorded and used to determine the location, or an approximate location of where the tree fell of. For example, if the speed of the equipment is also being monitored, then the speed of the equipment and time the tree fell off may be used to determine approximately the distance along the path where the tree fell off. Alternatively, the time alone may provide some indication of where on the route the tree fell off.

In one embodiment, the tree relocation phase may include the distribution of tree byproducts into a particular region. There may be times when it is desirable to distribute tree byproducts back into the area being harvested. One way of doing this may be to have the tree relocation machine bring cut trees to the processing/transportation region, then pick up a load of tree byproducts and distribute the byproducts through the region on the way to pick up another load of cut trees. In this embodiment, characteristics such as the quantity, loads and/or location of the placed byproducts may be established. In addition, the tree relocating machine may receive instructions from another machine (e.g., another mobile communicator 206) or a remote facility, regarding the location of the cut trees to be picked up or the location to distribute the tree by-products.

In one embodiment of the present invention, characteristics of the tree harvesting process may be established during the tree transportation phase. The tree transportation phase may include the processing and loading of the trees onto a piece of transportation equipment. In one embodiment, the characteristics determined during the transportation phase include, number of trees transported on a piece of transportation equipment, and/or in total, the weight of trees transported on a transportation equipment, or in total, the species of trees loaded on the transportation equipment. In addition, characteristics associated with the length of the trees loaded into a transportation equipment, or overall, the weight of tree byproducts loaded onto the transportation equipment, the location the trees are to be delivered to, the location the trees are actually delivered, and characteristics of the weight of the transportation equipment. Length characteristics of the cut trees may include buck length of the trees, average buck length of the trees, etc. In one embodiment, the transportation equipment is a truck, and the weight characteristics of the truck may include the gross weight, tare weight, payload weight etc.

In one embodiment, the tree transportation phase may include a tree processing phase. The tree processing phase may include delimbing a tree, cutting the tree into two or more portions, and/or processing the tree, or portions of the tree into tree byproducts. The characteristics that may be established during the processing phase may include, one or more of the characteristics of the byproducts produced, e.g., volume, weight, or type of byproduct produced, a length characteristic of the tree before and/or after processing, the number of trees processed, the weight of the trees processed, the time intervals of the trees processed, the species of the trees processed etc.

In one embodiment of the present invention, at least some of the characteristics of the harvesting process may be established during more than one of the phases. For example, the tree weight may be established during the cutting phase, the relocating phase and, or the transportation phase. In addition, characteristics such as the species, density, moisture content, and diameter of the tree may be established during the tree cutting phase and/or the transportation phase, and depending on the equipment used, during the relocation phase.

In one embodiment, as illustrated in a second control block 504 of FIG. 5, once characteristics of the tree harvesting process have been established at a first location they may be delivered to a second location. For example, the second location may be another mobile communicator 206 (e.g., a communicator 206 located on another machine) involved in the tree harvesting process, and/or a remote facility.

In a third control block 506 the tree harvesting process may be monitored in response to the plurality of characteristics. Monitoring the tree harvesting process may include analyzing the plurality of characteristics, and/or taking an action based on the analysis, or based on one or more of the established characteristics. For example, the characteristics may be recorded for later analysis regarding productivity and management information: types of trees cut, weight of trees cut, number of trees cut, trees from a particular region, amount and type of tree byproduct created, where and how much tree byproduct was placed down, tree stump height and comparison with regulatory issues, the location of lost trees, amount of access paths used, potential need to create additional access paths, need to modify an access path, route planning, hour/meter/machine maintenance issues, logistics/scheduling issues (making sure workflow is at an appropriate level), regulatory/environmental compliance, productivity issues, etc.

### Industrial Applicability

The present disclosure includes a method and apparatus configured to monitor a tree harvesting process. The method includes the steps of establishing a plurality of characteristics of the tree harvesting process associated with a first location, delivering the plurality of characteristics to a second location, and monitoring the tree harvesting process in response to the plurality of characteristics.

In one embodiment, a tree cutting machine will enter a region to cut a tree. The region the machine enters may be a predefined region. For example, an area having trees to be harvested may be further segmented into regions, or blocks. The segmentation of a region may be performed by segmenting a map of the area, either manually or electronically (e.g., in an automated manner), into the predefined regions, and then storing the coordinates for the regions. Therefore, characteristics such as area segmentation may be established based on the number of machines available, the access paths available etc. In one embodiment, this area segmentation may be performed at a remote facility 208. The segmentation, or a portion thereof, may be delivered to a tree cutting machine. The trees to be cut in a particular region may be predetermined. For example, a person, or machine, may traverse the area and identify the trees to be cut. The identification may include physically marking the tree or storing the location of the tree (e.g., coordinates of the tree) and recording the location of the trees in the remote facility 208. In one embodiment, the remote facility 208 may receive aerial or satellite information through which the location of trees may be determined. The information may enable particular trees, or groups of trees, to be designated for cutting. The location of these trees may then be recorded into a repository, e.g., a database, in the remote facility 208. Therefore, in one embodiment, a repository of information, including characteristics associated with the tree harvesting process, may be developed. The information may include an electronic copy of a map of the area, the regions the area is segmented into, and the location of trees to be cut within the region.

In one embodiment, a transportation location may be identified. The transportation location may be the location from which the trees are transported to a processing facility. The transportation location may be identified based on the topography, of the area, or the location of the trees to be cut, or the location of the transportation medium to be used. For example, if trucks are to be used for transportation, then the transportation location may be located for convenient access to the roads. If barges are to be used, then the transportation region may be conveniently located to the water. Alternatively, if the trees to be cut are predominately out of regions closely located, then the transportation location may be established close to the regions having the predominate harvest. One or more transportation regions may be established. The number of regions may depend upon the size and/or layout of the harvesting area. Therefore, the transportation region(s) may be a characteristic established.

The database of information associated with the tree harvesting process may also include information associated with available and/or planned access paths, available equipment, work assignments for particular regions and/or equipment etc.

Work distribution, or work assignments may established based on the information associated with the tree harvesting process. For example, the regions may be assigned to one or more machines responsible for cutting down the trees. The regions may also be assigned to one or more machines responsible for relocating the cut trees from the cutting region to the transportation region.

In one embodiment, at the beginning of a shift (or at any other time during the day or tree harvesting process), a work assignment may be distributed to a particular piece of equipment. For example, the remote facility 208 may send a work assignment to a particular piece of equipment via communication network 210 and the mobile communicator 206 located on the equipment. The work assignment may include the location of the region the equipment is to operate within, the location of the trees the equipment is to cut within the region, the number of trees to cut within the region, time metrics associated with how fast the trees are to be cut. For example, time metrics may be based on the total number of trees that are needed to be cut during the day, or the speed at which the trees should be cut in order to keep the work flow at the appropriate level. That is, it may be determined that a machine responsible for relocating the cut trees is able to service the region every thirty minutes. Therefore, it may be desired to have a specified number of trees cut and made ready for relocation by the cutting machine every thirty minutes. In one embodiment, a work assignment may be generated in response to the tree harvest characteristics. That is, one machine indicates it has finished a task (e.g., cutting trees, or grouping trees), it may generate a request for the trees to be picked up. The request may generate what is in effect a work assignment, by either a tree relocation machine that responds to the request, or the remote data facility that receives the request and identifies a machine to respond to the request.

In one embodiment, the location of the trees to be cut may be delivered to the machine. In addition, the route to be taken to the region to be harvested may be included in the work assignment transmitted to the cutting equipment. In one embodiment, the work assignments may be downloaded onto hand held devices that are picked up by the operators of the equipment. The information may be used via the hand held device, or downloaded to the machine once the operator arrives at their machine.

Once the cutting machine receives the work assignment, the machine may traverse the designated route, if one is provided, to the region to be cut. For example, the operator may pull up an assignment on screen if desired/available. In one embodiment, the operator may view a display illustrating the route to take to the assigned region, the location of the trees to be cut, and the order in which the trees are to be cut.

Once the cutting machine is in the region, a tree to cut may be identified. The identification may be made visually if the tree was physically marked in advance, or a tree location may be communicated to an operator. For example, if locations of trees to be cut are stored on the equipment, and if a display is used, the location of the trees to be cut may be displayed relative to the position of the machine. The stored information may be delivered to the machine (e.g., via the communication network, or a data link to a service tool or hand held device, or entered via an operator input device). In one embodiment, the operator may determine which trees to cut upon their own initiative. Once they reach the cutting region. The operators may make this decision based upon the number of trees to be cut, the percentage of trees to be cut, or both. Once a tree has been identified to be cut, the operator may then cut the tree down with the machine. The location of the tree that was cut may be stored.

The location of the cut tree may be established in one of several ways. For example, in one embodiment, when a tree is cut, the operator may push a button or enter information into the system that signals the system to store the current location of the tree being cut. Alternatively the location where a tree is cut may be determined by an event. For example, there may be a unique function performed by the machine that is performed when a tree is being cut. The location of the tree may be determined by establishing when the function occurs and establishing location information regarding the position of the machine, and therefore the location of the tree. Alternatively, or in addition, there may be a machine position that is achieved during the cutting of the tree. Therefore, by monitoring the machine position, the time that a tree is being cut may be determined. The location of the tree may then be determined based upon position of the machine when the tree was cut. In one embodiment, the location may be determined based upon the GPS inputs. Alternatively location may be determined relative to a base station or region. For example, the distance and direction traveled from the transportation region by a machine may be monitored. Based on this distance and direction a relative location of the tree may be established. If additional accuracy is desired, the actual location of the tree may be determined based on the relative location, and a known location of the base station or transportation region.

In one embodiment, additional characteristics of the tree may be determined during the tree cutting process. For example the density, weight, species, moisture content, and/or diameter of the tree may be recorded using devices such as X-ray, sensors, lazer, encoders. In addition, the stump height of a particular tree may be stored. The stump height may be determined either manually by physically measuring the height, or in an automated manner, such as measuring saw and linkage coordinates and vehicle grade positioning. In addition, characteristics of wheel slippage may be stored. The characteristics may include the location the wheel slippage occurred, or the severity of the wheel slippage, and the magnitude of the difference in the revolutions per minute of the wheels or tracks may be used to determine when the wheel slippage occurred, or the difference in the revolutions per minute compared with an expected revolutions per minute, and to what degree the slippage was. In addition, the length and depth of the slippage may be established and stored.

Once cut, the tree may fall to the ground and left there to be picked up by the tree relocating machine. In this case the location where the tree fell, or was cut, may be stored. Alternatively, the tree may be placed with a group, or bunch of trees, that have been cut. In this case, the location of the bunch of trees may be stored.

The established characteristics may be transmitted to a second location. For example, once a tree has been cut, and the characteristics of the tree, e.g., species, weight, diameter, moisture content etc. have been established, these characteristics may be transmitted back to the remote facility 208. Alternatively these characteristics may be stored until the end of a designated time period or an event occurs, and then sent to the remote facility 208. At least a portion of these established characteristics may be communicated to another piece of equipment, such as a tree relocation machine. For example, in one embodiment, when a tree relocation machine, such as a skidder-forwarder, enters a region to pick up cut trees, the skidder-forwarder may send a location request to the tree cutting machine, such as a feller. The feller may respond with the location of the bunch(es) of trees that have been assembled up to this point. Alternatively, if the feller is not bunching the trees, the location of the individual trees may be transmitted to the skidder, so the skidder may pick up the trees. In addition, tree characteristic information, such as weight and species and number may be transmitted to the skidder. The skidder may use this information to determine where to relocate the trees. For example, different species of trees may have different transportation regions. Therefore, when the feller cuts the trees, the feller may place the trees into different bunches according the species of the trees. The skidder may then pick up a particular bunch of trees to relocate them to a place where that particular species is being processed.

In one embodiment, the tree cutting machine may request a tree relocation machine to pick up the cut trees. The request may be initiated by the tree cutting machine, or in response from a request from another mobile communicator 206 (e.g. located on another piece of equipment or with a person) or remote facility 208. For example, once a particular number of trees have been cut, or a certain weight of cut trees has been obtained, the tree cutting machine may send a request for pickup, along with the location of the trees to be picked up, and possibly the number and/or weight of the trees. The request may be sent to the remote data facility where it is distributed to an appropriate tree relocation machine. Alternatively the request may go to a particular machine responsible for servicing the region the tree cutting machine is in. Alternatively, the request may be broadcast to tree relocating machines, and the next available tree relocating machine may respond. In one embodiment, the request for tree pickup may be made in advance of a load or number threshold. For example if a skidder is able to carry ten trees that have been cut, the request for pickup may be delivered to the skidder after the eighth tree has been cut. Therefore, by the time the skidder arrives to pick the trees up, the ninth and tenth trees have been cut. The number of trees used for the request threshold (i.e. when the request is made for pickup) may be based on the estimated amount of time it will take for the tree relocation machine to arrive at the location to pick up the cut trees. The request threshold may be a predetermined number, or a dynamically determined number based upon the particular work assignments, access paths, distance to be covered by the machines etc.

In an alternative embodiment, the established characteristics may be transmitted to the remote facility, and the remote facility may determine how to record, analyze and/or redistribute the information accordingly. For example, the remote facility may receive characteristics indicating the number of trees cut or weight of the trees cut by a particular machine, or grouped in a particular bunch, and then responsively determine when the trees are ready to be picked up. A tree relocating machine may then be notified, e.g., one responsible for that particular region, or the next available tree relocating machine.

In one embodiment, a tree relocating machine, e.g., a skidder-forwarder, may receive a work assignment. The work assignment may be received from the remote data facility, entered manually into the system by the operator of the machine, or received from another machine, e.g., via a mobile communicator 206, or person using a mobile communicator 206. The work assignment may include a terrain map of the area, and the associated regions (if used). The assignment may also include the regions that the skidder is responsible for servicing, e.g., by removing the cut trees to the transportation region and/or processing region. The assignment may include the location of the transportation region, i.e., the location the cut trees are to be delivered, and the routes to be used to traverse between the pick up points where the trees are located and the transportation region, and routes to be used within the regions. The work assignment may be delivered at the beginning of a shift, or anytime during a shift, and/or anytime during the operation of the machine.

Once the work assignment has been received, the skidder may begin traversing a recommended route, or a route the operator determines to use, to service regions or particular pick up points. In one embodiment, the skidder may have a set procedure to follow. For example, the skidder may pick up the trees cut by a first tree cutting machine, relocate the trees, then pick up the trees cut by a second tree cutting machine, relocate those trees, then return to service the first tree cutting machine and so on. Alternatively, the skidder may dynamically receive a request to pick up cut trees at a particular location. For example the work assignments for a particular skidder may not be known until a request for tree pick up is received. In one embodiment, a service request may be received from either a tree cutting machine, or the remote facility 208, indicating one or more trees is ready to be relocated, and the location of the trees. Alternative embodiments may include predefined bunching locations such that when a request is received to service a particular region, the apparatus 402 or operator already know where the cut trees will be located. In one embodiment, the service request may include the number of trees cut, the weight of one or more of the trees, the average weight of the trees, and/or the total weight of the cut trees in a bunch. The service request may include updated information regarding desired routes to take, or the location of areas where wheel slippage occurred. A route recommendation for the skidder may be modified in response to identified areas where wheel slippage has occurred. An alternative route may be taken, or a pre-defined route may be modified to avoid the area of wheel slippage.

Once the skidder arrives at the designated location of the cut trees, the skidder may begin loading the trees for the purpose of relocating them to the transportation region. As the skidder loads the cut trees, the apparatus 202 associated with the skidder, may record the weight of the trees being loaded. In one embodiment, this may be done using a system capable of determining a characteristic of weight. The number of cut trees loaded may also be determined and stored. The number of cut trees may be determined by the operator and entered into the system via the operator interface. In one embodiment, the weight information established by the skidder may be cross correlated with the weight information from the machine cutting the trees, and the results displayed to the operator. In this manner the operator of the machine may determine if all the trees in a particular bunch have been picked up. For example, if the weight of a bunch is established to be 500 pounds, and the weight of the trees picked up from the bunch is 450 pounds, the operator may be notified (e.g., via the display) that there is one or more cut trees to be picked up on the bunch, or notified that there is a discrepancy between the weight picked up and the weight in the bunch before loading began, or notified of the two weights (before loading and currently loaded) and the operator may determine whether there is a discrepancy.

Once the skidder has acquired a load of cut trees, the skidder may begin to travel towards the processing and/or transportation region. As the skidder travels towards the processing/transportation region, the apparatus 202 may monitor the weight of the load being carried to determine if a tree is dropped, as previously discussed.

The skidder may identify one or more characteristics of wheel slippage that occur on the way to or from the transportation region. For example, the location and/or amount of wheel slippage that occurs in route, or at the loading/unloading areas, may be recorded. The wheel slippage information may be transmitted to other machines that may traverse the same route, and/or to the remote data facility. The remote facility 208 may determine what action to take based on the wheel slippage. For example, an alternative route may be recommended (or broadcast) to any machine traversing the analyzed route. Alternatively, the route may be modified to avoid the area of wheel slippage. The modified route may then be delivered to all machines, or the machines that would be traversing the route at issue. In one embodiment, the skidder may use the wheel slippage information to determine a modified route on its own, and use that to traverse between the cut trees and the transportation region. The modified route, or alternative route, may then be transmitted to one or more machines and/or the remote data facility.

In addition, the number of trips between the cut trees and the tree transportation region may be determined. This information may be used, in part, to establish an efficiency characteristic for the harvesting process. For example, how many trips are being take, how many trees are being relocated, in total or on average, how much weight is being relocated, in total or on average etc. This information may be used to determine if the skidder is being most effectively used. For example, is the skidder appropriately loaded, is the skidder arriving to pick up points at the appropriate times, is the skidder having to wait at a pick up point for additional trees to be cut, are the routes taken by the skidder effective and/or efficient. This information may be transmitted to the remote facility 208 for additional processing/recording, or distribution.

The location of the skidder on the route may also be determined. This may be used, for example, to provide the remote data facility or transportation region an indication of when the skidder will arrive with the cut trees. For example, the location on the route and current machine speed may be used to determine the amount of time before the skidder arrives at the transportation region. One or more characteristics such as the weight information, species of trees, number of trees, moisture content of trees, characteristic indicative of time of arrival to a particular area may be transmitted to the transportation region and/or the remote data facility. As will be discussed below, the transportation region and/or remote facility may use this information for planning purposes.

In one embodiment, a machine in the transportation region may receive a work assignment from the remote facility 208. For example, the machine may be a transportation piece of equipment such as a truck, barge, railroad car etc. The work assignment may include information regarding where the equipment should be located to pick up a load of cut trees. The transportation equipment may be located in a common region or portion thereof. Depending on the nature of the harvesting process, the transportation region may include the transportation of multiple types of tree species to different facilities, or different processing areas within a facility. Therefore, the loading of the species into the equipment may occur in different portions of the harvest area. For example, the tree relocating machine, such as a skidder, may unload the cut trees of one species type in a region designated for that species. The species may be processed and loaded onto the equipment, such as trucks, assigned to that region. In this manner, if different species have different processing and/or transportation issues, the issues may be addressed in the different regions thereby reducing confusion, and/or increasing the efficiency of the process. Alternatively the cut trees may be processed and loaded on the trucks for transportation anywhere in the region.

Once a truck is located in the transportation region, the truck may be loaded. In one embodiment, the skidder unloads the cut trees into bunchs. A loading machine may pick up the cut trees and load them into the truck for transportation. In an alternative embodiment, the skidder may unload the cut trees directly into the transportation machine.

In one embodiment, the transportation region may include a processing region. Alternatively the processing region may be considered a separate region. A processing machine, such as a delimber and/or saw, is located in the transportation region. The delimber may receive the cut trees from the skidder, process the trees, and then a loader machine may load the trees onto the truck. In one embodiment, the skidder may transmit an indication of time of arrival to the remote facility and/or a machine in the processing/transportation region. The information may be used to perform a type of work load distribution. For example, if multiple processing machines, e.g., delimbing machines or saws, are operating in a transportation region, the remote facility may determine which processing machine should process the cut trees being transported by the skidder. For example, the remote facility may know, based on prior information received from the equipment involved in the harvesting process, how many trees are located at each processing machine or the weight of the trees at each processing machine, or the species of the trees at the processing machines. Based on this information, the remote facility, or one of the machines in the transportation region, may be able to distribute the incoming trees of the skidder, to the appropriate processing machine in order to maintain a desired work flow. For example, if one processing machine has a lot of trees to process, while another has none, then the equipment may not be being used in an effective manner. Therefore, the remote facility may direct the skidder to unload the cut trees at a particular processing machine, or multiple processing machines, to maintain an appropriate work flow.

In one embodiment, once the trees have been processed, they may be loaded onto a transportation equipment by a loading machine, such as a logger. The processing machine, or the loading machine, may transmit tree characteristic information to the piece of transportation equipment. For example the processing machine may transmit to the loading machine the characteristics of the tree, as it is processed, e.g., the tree species, diameter, moisture content, weight of the tree, weight of the tree segments, weight of the tree by-products, length of the tree, length of the tree segments. The loading machine may then transmit this information to the transportation equipment on which it loads the tree, tree segment, or tree by-products into and/or the remote data facility. In one embodiment, the loading machine may transmit a payload capability request to the transportation equipment, e.g., truck. The truck would then respond with payload information associated with the payload capability of the truck. For example, the truck may be capable of carrying 1000 pounds or ten twelve foot trees, which ever is less. In this manner, the loading machine can monitor how much is being placed in the truck so that the truck is not overloaded. In some cases, this may mean additional review of the information received from the processing machine associated with the tree characteristics. That is, some processed trees may be placed aside while loading a truck so that the trucks payload capability is effectively utilized while not overloading the truck. If a truck is associated with a particular processing machine, the processing machine may send tree characteristics directly to the truck.

In one embodiment, the remote facility 208 may receive the loading information from the loading machine, and then determine where the desired destination of the transportation equipment is. The desired destination may include a saw mill, pulp mill, log yard, rail spur, etc. The desired destination may then be delivered to the transportation equipment being loaded.

In one embodiment, the truck may receive payload information from the loading machine. In one embodiment, the truck may compare the payload information with internal payload measuring system, if applicable, to correlate the measurements. In addition, when a truck is weighed, for example, on highway or at a mill, the payload weight may be used to ascertain the weight of the truck. If the truck weight exceeds a desired weight, the operator may determine why there is a discrepancy. For example, during the winter, trucks accumulate snow and ice on the frame or from part of the payload. The truck operator may determine whether the weight of the machine exceeds a desired weight, and if so, analyze the machine to determine if snow and/or ice has accumulated and needs to be removed.

In one embodiment, the processing machine may process the tree, or portions of the tree, e.g., tree tops, into tree by products. The tree by-products may be loaded onto the transportation equipment by the loader, as described above. Alternatively, the by-products may be taken by the tree relocating machine, e.g, skidder, and dropped back into the woods. Therefore, in one embodiment, a skidder may be given the work assignment of taking tree by products back into the woods. For example, the remote facility may determine that the tree by-products need to be distributed in the woods, determine the desired regions in which to distribute the by-product, determine the machine to perform the by-product distribution, such as a skidder, and then transmit the task information to the designated skidder. Then, once the processing machine has processed some tree by-products, the processing machine may notify the remote facility 208 to notify a skidder to pick the byproducts up. Alternatively the processing machine may notify the designated skidder directly. In addition, this task assignment may be identified in advance, before the processing occurs, so that the remote facility 208 may plan the resources, e.g., skidder, needed to complete the task, and make sure they are there at an appropriate time.

In one embodiment the remote facility 208 performs a resource allocation function. That is, the remote data facility receives the characteristics associated with the tree harvesting process and uses this information to either plan the resource allocation, or to ensure the resource allocation that was planned is operating appropriately. For example, if trucks are spending time waiting to be loaded, the remote facility 208 may determine if the issue is that the processing machines are not operating fast enough, more processing machines are needed, the tree cutting machines are not operating fast enough, more of them are needed. The operation of the tree relocating machines may also be reviewed to determine if they are operating as desired, or if more of them are needed. If one or more of the tree cutting machines is behind a desired schedule, the remote facility may notify the machine to determine what may be done to increase productivity. Alternatively, the tree cutting machine may have the ability to compare its performance with a stored desired performance to determine if it is operating at the desired operating level. If the machine is behind schedule, the apparatus 202 may notify the operator of the issue.

In one embodiment, the remote facility 208, or other piece of equipment, may receive a plurality of characteristics regarding the tree harvesting process from one or more pieces of equipment involved in the process. As discussed, the information could be tree characteristic information, such as the weight, density, moisture content, species of the trees being cut, the location of the trees being cut in the harvesting process (e.g., the tree cutting phase, relocation phase, transportation phase), the location of the equipment used in the process, productivity characteristics of the process, and environmental characteristics of the process. These characteristics may be used by the remote data facility to monitor one or more aspects of the tree harvesting process, as described above. Other characteristics that may be monitored, include characteristics of the trees being cut (as described above), characteristics of productivity issues, work flow issues, coordination issues, equipment maintenance issues, equipment status issues, environmental issues, planning issues etc., as described throughout. The monitoring process enables the remote data facility to manage the operations of the harvest process. For example, the remote data facility may determine and distribute work assignments to machines to appropriately allocate the resources available to the process. In addition, the monitored characteristics will help identify bottlenecks in the process so that work load redistribution may be performed if need be, or other appropriate action may be taken. In addition, payload information from the transportation equipment may be monitored to ensure that the equipment, e.g., trucks, is not overloaded, thereby reducing the risk of long term harm to the equipment due to overloading. In addition, by monitoring the service hours of the equipment, the remote data facility can proactively plan when maintenance of the machines should occur, and ensure the resources are available to keep the process operating when machine maintenance is necessary.

In one embodiment, productivity information, or machine associated information may be transmitted from the remote data facility to a second data facility, such as a customer office, a dealers office, or a manufacturers office. In this manner, the appropriate parties may monitor the performance/operation of the machines they are associated with.

Control of the harvesting process may be centrally controlled by the remote data facility. That is, all, or a significant portion of the analysis, workload distribution, task assignments, and productivity analysis is performed by the remote monitoring facility, and then transferred to a machine, where appropriate, for a designated action to take place, e.g., pick up trees at this location. Alternatively, the control of the harvesting process may be distributed where the machines involved in the process communicate information with each other and may make request of other machines involved in the harvesting process. In addition, a combination of central and distributed control may be used to monitor and manage the tree harvesting process.

The equipment used in a tree harvesting process may include tree cutting equipment, tree grouping equipment, tree relocating equipment, tree processing equipment, tree loading equipment, and transportation equipment. In addition, other forms of equipment may be used such as generator sets, or other forms of mobile machines (e.g., trucks traversing the area to monitor activity etc.).

In one embodiment, the information transmitted between machines, or between the machines and the remote data facility, may be done in predefined message packets indicating the appropriate information. For example, particular information may be requested from one machine, or the remote data facility, and the requested data delivered in a predefined data packet.

Other aspects, objects, and advantages of the present invention can be obtained from a study of the drawings, the disclosure, and the claims.

What is claimed is:

1. A method of managing a tree harvesting process, comprising the steps of:
establishing a plurality of characteristics of said tree harvesting process at a first location;
delivering said plurality of characteristics to a second location;
managing said tree harvest process in response to said plurality of characteristics.

2. A method, as set forth in claim 1, wherein the step of establishing said plurality of characteristics further comprises the step of establishing said plurality of characteristics of a tree cutting phase of said tree harvesting process, said characteristics being established by a first piece of equipment.

3. A method, as set forth in claim 1, wherein the step of establishing said plurality of characteristics further comprises the step of establishing said plurality of characteristics of a tree relocation phase of said tree harvesting process.

4. A method, as set forth in claim 1, wherein the step of establishing said plurality of characteristics further comprises the step of establishing said plurality of characteristics of a tree transportation phase of said tree harvesting process.

5. A method, as set forth in claim 1, wherein the step of establishing said plurality of characteristics further comprises the step of establishing said plurality of characteristics of a central management phase of said tree harvesting process.

6. A method, as set forth in claim 2, wherein the step of relaying said plurality of characteristics to a second location further comprises the step of relaying said plurality of characteristics to a second piece of equipment located at said second location.

7. A method, as set forth in claim 6, wherein the step of relaying said plurality of characteristics to said second location further comprises the step of relaying said plurality of characteristics to said second piece of equipment located at said second location and performing one of said tree cutting phase, said tree relocation phase, and said tree transportation phase.

8. A method, as set forth in claim 1, wherein said plurality of characteristics includes at least two of a tree diameter, number of trees cut, number of trees relocated, number of trees transported, species of tree cut, species of tree relocated, species of tree transported, density of tree cut, density of tree relocated, density of tree transported, moisture content of tree cut, moisture content of tree relocated, moisture content of tree transported, stump height of tree cut, wheel slip characteristic in harvesting process, hour meter of at least one of said first equipment and said second equipment, location of said cut tree, location of said tree relocation, number of cut trees located in a group, weight of, tree cut, weight of tree relocated, weight of tree transported, weight of trees cut, weight of trees relocated, weight of trees transported, number of lost trees, location of lost trees, number of relocating trips, number of transportation trips, number of trucks loaded, bucked length of trees transported.

9. A method, as set forth in claim 1, further comprising delivering a harvest segmentation to said first location from said second location.

10. A method, as set forth in claim 9, wherein said harvest segmentation is determined based upon at least one of a number of available machines, a number of access path, a total size of a harvest area, and a location of a tree transportation location.

11. A method, as set forth in claim 1, wherein a tree transportation region is established in response to at least one of a topography, a location of trees to be harvested, a type of transportation medium to be used, and a location of said transportation to be used.

12. A method, as set forth in claim 1, wherein the step of managing said harvest process further comprises the step of establishing a work assignment in response to said plurality of tree harvesting characteristics.

13. A method, as set forth in claim 12, further comprising the step of delivering said work assignment to a third location.

14. A method, as set forth in claim 1, wherein the step of managing said tree harvest process includes at least one of determining a productivity characteristic of said tree harvest process, determining a work flow of said process, determining an environmental characteristic, determining a work load distribution, and coordinating with multiple machines, in response to said tree harvest characteristics.

15. A method of harvesting a tree comprising the steps of:
cutting down at least one tree;
relocating said at least one cut tree;
transporting said at least one cut tree;
establishing a plurality of characteristics at a first location associated with at least one of said tree cutting, said tree relocating, and said tree transporting; and
relaying said plurality of established characteristics to a second location.

16. A method of harvesting a tree, as set forth in claim 15, wherein said second location is associated with one of said tree cutting, said tree relocating, said tree transporting, and a central data facility.

17. A system configured to manage a tree harvesting process, comprising:
a local harvest monitoring system configured to establish a plurality of tree harvesting characteristics associated with said tree harvesting process and responsively generate a signal, said signal being indicative of at least a portion of said tree harvesting characteristics; and
a remote data facility configured to receive said signal and manage said tree harvest process in response to said tree harvesting characteristics.

18. A system, as set forth in claim 17, wherein said local harvest monitoring system further comprises:
at least one sensing device configured to sense information, and responsively generate an information signal;
a controller configured to receive said sensed signal, establish a plurality of tree harvesting characteristics in response to said sensed signal, and deliver at least a portion of said tree harvesting characteristics to a mobile communicator; and
said mobile communicator responsively configured to receive said tree harvest characteristics and responsively deliver a signal indicative of said tree harvest characteristics to said remote data facility.

19. A system, as set forth in claim 17, wherein said tree harvesting characterstics are associated with a tree cutting phase of said tree harvesting process.

20. A system, as set forth in claim 17, wherein said tree harvesting characteristics are associated with a tree relocation phase of said tree harvesting process.

21. A system, as set forth in claim 17, wherein said tree harvesting characteristics are associated with a tree transportation phase of said tree harvesting process.

22. A system, as set forth in claim 17, wherein said tree harvesting characteristics are associated with a tree processing phase.

23. A system, as set forth in claim 17, wherein said tree harvesting characteristics are associated with a tree grouping phase.

24. A system, as set forth in claim 17, wherein said plurality of tree harvesting characteristics includes at least two of a a tree diameter, number of trees cut, number of trees relocated, number of trees transported, species of tree cut, species of tree relocated, species of tree transported, density of tree cut, density of tree relocated, density of tree transported, moisture content of tree cut, moisture content of tree relocated, moisture content of tree transported, stump height of tree cut, wheel slip characteristic in harvesting process, hour meter of at least one of said first equipment and said second equipment, location of said cut tree, location of said tree relocation, number of cut trees located in a group, weight of, tree cut, weight of tree relocated, weight of tree transported, weight of trees cut, weight of trees relocated, weight of trees transported, number of lost trees, location of lost trees, number of relocating trips, number of transportation trips, number of trucks loaded, bucked length of trees transported
